(19) United States
(12) Patent Application Publication
(10) Pub. No.: US 2003/0169255 A1
(43) Pub. Date: Sep. 11, 2003

(54) Two-sided lighting in a single pass

(76) Inventors: Michael G. Lavelle, Saratoga, CA (US); Wayne A. Morse, Freemont, CA (US); Charles F. Patton, Dublin, CA (US); Ewa M. Kubalska, San Jose, CA (US); Mark E. Pascual, San Jose, CA (US); Nandini Ramani, Saratoga, CA (US)

Correspondence Address: Jeffrey C. Hood, Conley, Rose, & Tayon, P.C., P.O. Box 398, Austin, TX, 78767, US

(21) Appl. No.: 10/094,936

(22) Filed: Mar. 11, 2002

(51) Int. Cl. G06T 15/60

(52) U.S. Cl. 345/426

(57) ABSTRACT

A graphics system for providing two-sided lighting. The graphics system may include a media processor and a hardware accelerator. The media processor may be configured to receive a stream of vertices, and to perform a two-sided lighting computation on each vertex resulting in front color and back color for each vertex. The hardware accelerator may be configured to (a) receive the vertices of the first stream along with the front and back color for each vertex, (b) assemble the vertices into polygons, (c) compute an orientation for each of the polygons, (d) select the front color or the back color of the vertices forming each polygon based on a result of the orientation computation for each polygon, and (e) render each polygon using the selected color of the vertices forming the polygon.

### BACKGROUND OF THE INVENTION

1. Field of the Invention

This invention relates generally to the field of computer graphics and, more particularly, to graphics system and method for performing two-sided lighting.

2. Description of the Related Art

The following is an excerpt from the OpenGL Programming Guide, Second Edition, Addison Wesley, Copyright 1997:

“Lighting calculations are performed for all polygons, whether they're front-facing or back-facing. Since you usually set up lighting conditions with the front-facing polygons in mind, however, the back-facing ones typically aren't correctly illuminated. In Example 5-1 where the object is a sphere, only the front faces are ever seen, since they're the ones on the outside of the sphere. So, in this case, it doesn't matter what the back-facing polygons look like. If the sphere is going to be cut away so that its inside surface will be visible, however, you might want to have the inside surface be fully lit according to the lighting conditions you've defined; you might also want to supply a different material description for the back faces.”

This excerpt from the OpenGL Programming Guide illustrates that programmers may desire to light and render the back side of some polygons and the front side of other polygons in a graphics scene. Thus, there exists a need for a graphics accelerator capable of lighting and rendering the front side of some polygons and the back side of other polygons in an efficient fashion.

### SUMMARY OF THE INVENTION

In one set of embodiments, a graphics system for providing two-sided lighting may be configured as follows. The graphics system may include a media processor coupled to a hardware accelerator. The media processor may be configured to receive a stream of vertices, and to perform a two-sided lighting computation on each vertex resulting in front color and back color for each vertex. The hardware accelerator may be configured to:

(a) receive the vertices of the first stream along with the front and back color for each vertex,

(b) assemble the vertices into polygons,

(c) compute an orientation for each of the polygons,

(d) select the front color or the back color of the vertices forming each polygon based on a result of the orientation computation for each polygon,

(e) render each polygon using the selected color for the vertices forming the polygon.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 is a perspective view of one embodiment of a computer system;

FIG. 2 is a simplified block diagram of one embodiment of a computer system;

FIG. 3 is a functional block diagram of one embodiment of a graphics system;

FIG. 4 is a functional block diagram of one embodiment of the media processor of FIG. 3;

FIG. 5 is a functional block diagram of one embodiment of the hardware accelerator of FIG. 3;

FIG. 6 is a functional block diagram of one embodiment of the video output processor of FIG. 3;

FIG. 7 is an illustration of a sample space partitioned into an array of bins;

FIG. 8 illustrates one embodiment of hardware accelerator 18 which emphasizes a presetup unit and setup unit inside the render pipe 166;

FIG. 9 illustrates one embodiment of the setup unit configured to determine triangle orientation and to select front or back vertex color of each triangle; and

FIG. 10 illustrates one set of embodiments of a method for performing two-sided lighting.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).” The term “include”, and derivations thereof, mean “including, but not limited to”. The term “connected” means “directly or indirectly connected”, and the term “coupled” means “directly or indirectly connected”.

### DETAILED DESCRIPTION OF THE PREFERRED EMBODIMENTS

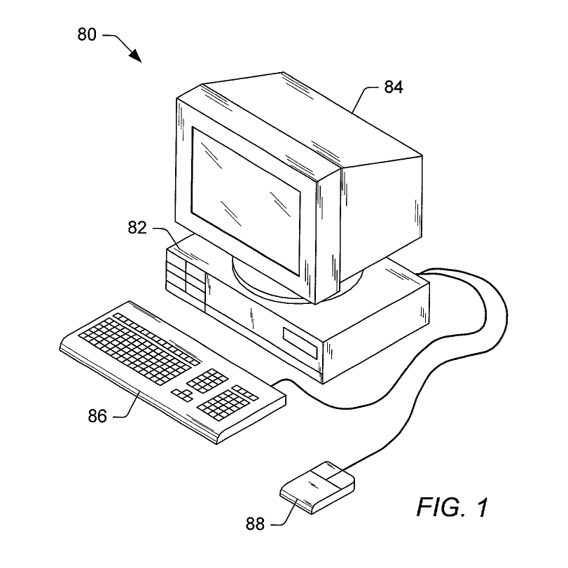

Computer System—FIG. 1

FIG. 1 illustrates one embodiment of a computer system 80 that includes a graphics system. The graphics system may be included in any of various systems such as computer systems, network PCs, Internet appliances, televisions (e.g. HDTV systems and interactive television systems), personal digital assistants (PDAs), virtual reality systems, and other devices which display 2D and/or 3D graphics, among others.

As shown, the computer system 80 includes a system unit 82 and a video monitor or display device 84 coupled to the system unit 82. The display device 84 may be any of various types of display monitors or devices (e.g., a CRT, LCD, or gas-plasma display). Various input devices may be connected to the computer system, including a keyboard 86 and/or a mouse 88, or other input device (e.g., a trackball, digitizer, tablet, six-degree of freedom input device, head tracker, eye tracker, data glove, or body sensors). Application software may be executed by the computer system 80 to display graphical objects on display device 84.

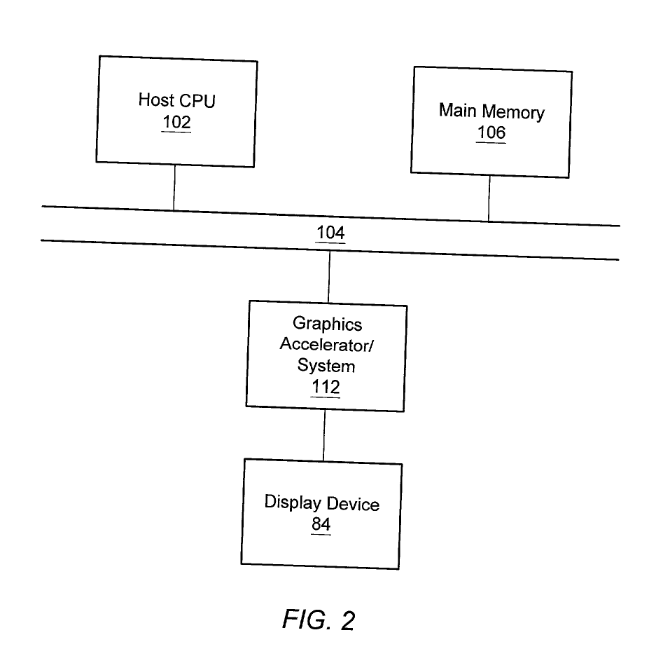

Computer System Block Diagram—FIG. 2

FIG. 2 is a simplified block diagram illustrating the computer system of FIG. 1. As shown, the computer system 80 includes a central processing unit (CPU) 102 coupled to a high-speed memory bus or system bus 104 also referred to as the host bus 104. A system memory 106 (also referred to herein as main memory) may also be coupled to high-speed bus 104.

Host processor 102 may include one or more processors of varying types, e.g., microprocessors, multi-processors and CPUs. The system memory 106 may include any combination of different types of memory subsystems such as random access memories (e.g., static random access memories or “SRAMs,” synchronous dynamic random access memories or “SDRAMs,” and Rambus dynamic random access memories or “RDRAMs,” among others), read-only memories, and mass storage devices. The system bus or host bus 104 may include one or more communication or host computer buses (for communication between host processors, CPUs, and memory subsystems) as well as specialized subsystem buses.

In FIG. 2, a graphics system 112 is coupled to the high-speed memory bus 104. The graphics system 112 may be coupled to the bus 104 by, for example, a crossbar switch or other bus connectivity logic. It is assumed that various other peripheral devices, or other buses, may be connected to the high-speed memory bus 104. It is noted that the graphics system 112 may be coupled to one or more of the buses in computer system 80 and/or may be coupled to various types of buses. In addition, the graphics system 112 may be coupled to a communication port and thereby directly receive graphics data from an external source, e.g., the Internet or a network. As shown in the figure, one or more display devices 84 may be connected to the graphics system 112.

Host CPU 102 may transfer information to and from the graphics system 112 according to a programmed input/output (I/O) protocol over host bus 104. Alternately, graphics system 112 may access system memory 106 according to a direct memory access (DMA) protocol or through intelligent bus mastering.

A graphics application program conforming to an application programming interface (API) such as OpenGL® or Java 3D™ may execute on host CPU 102 and generate commands and graphics data that define geometric primitives such as polygons for output on display device 84. Host processor 102 may transfer the graphics data to system memory 106. Thereafter, the host processor 102 may operate to transfer the graphics data to the graphics system 112 over the host bus 104. In another embodiment, the graphics system 112 may read in geometry data arrays over the host bus 104 using DMA access cycles. In yet another embodiment, the graphics system 112 may be coupled to the system memory 106 through a direct port, such as the Advanced Graphics Port (AGP) promulgated by Intel Corporation.

The graphics system may receive graphics data from any of various sources, including host CPU 102 and/or system memory 106, other memory, or from an external source such as a network (e.g. the Internet), or from a broadcast medium, e.g., television, or from other sources.

Note while graphics system 112 is depicted as part of computer system 80, graphics system 112 may also be configured as a stand-alone device (e.g., with its own built-in display). Graphics system 112 may also be configured as a single chip device or as part of a system-on-a-chip or a multi-chip module. Additionally, in some embodiments, certain of the processing operations performed by elements of the illustrated graphics system 112 may be implemented in software.

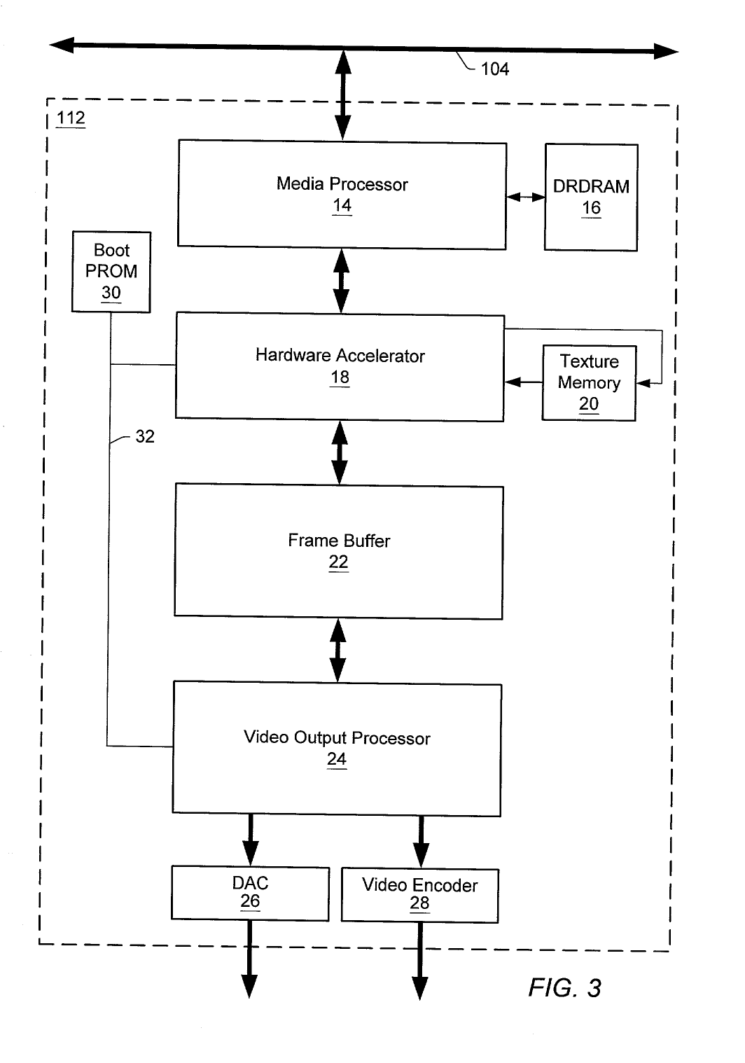

Graphics System—FIG. 3

FIG. 3 is a functional block diagram illustrating one embodiment of graphics system 112. Note that many other embodiments of graphics system 112 are possible and contemplated. Graphics system 112 may include one or more media processors 14, one or more hardware accelerators 18, one or more texture buffers 20, one or more frame buffers 22, and one or more video output processors 24. Graphics system 112 may also include one or more output devices such as digital-to-analog converters (DACs) 26, video encoders 28, flat-panel-display drivers (not shown), and/or video projectors (not shown). Media processor 14 and/or hardware accelerator 18 may include any suitable type of high performance processor (e.g., specialized graphics processors or calculation units, multimedia processors, DSPs, or general purpose processors).

In some embodiments, one or more of these components may be removed. For example, the texture buffer may not be included in an embodiment that does not provide texture mapping. In other embodiments, all or part of the functionality incorporated in either or both of the media processor or the hardware accelerator may be implemented in software.

In one set of embodiments, media processor 14 is one integrated circuit and hardware accelerator is another integrated circuit. In other embodiments, media processor 14 and hardware accelerator 18 may be incorporated within the same integrated circuit. In some embodiments, portions of media processor 14 and/or hardware accelerator 18 may be included in separate integrated circuits.

As shown, graphics system 112 may include an interface to a host bus such as host bus 104 in FIG. 2 to enable graphics system 112 to communicate with a host system such as computer system 80. More particularly, host bus 104 may allow a host processor to send commands to the graphics system 112. In one embodiment, host bus 104 may be a bi-directional bus.

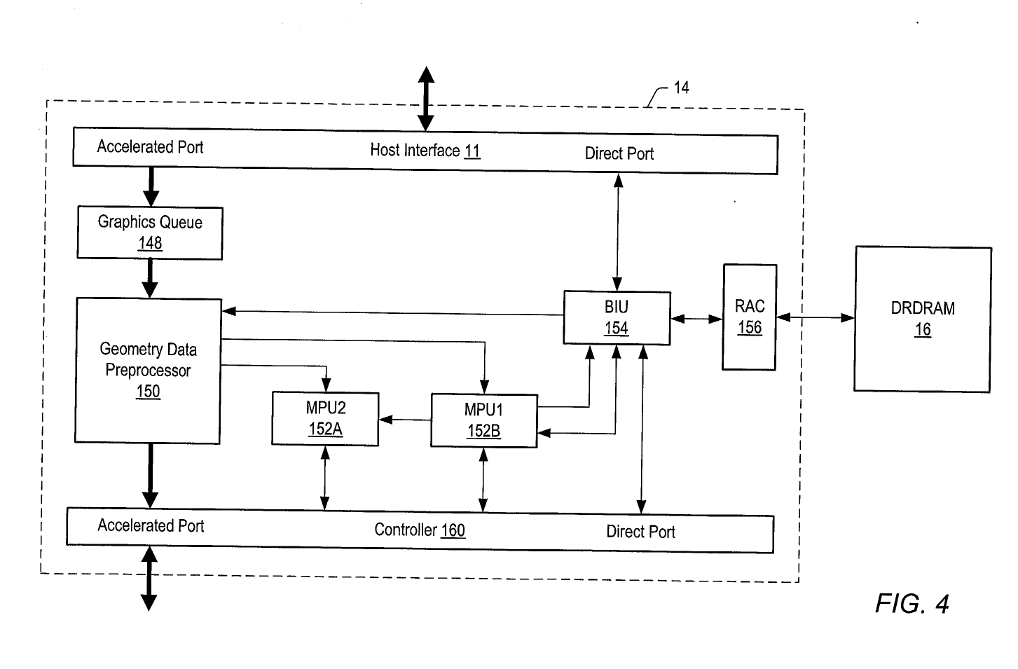

Media Processor—FIG. 4

FIG. 4 shows one embodiment of media processor 14. As shown, media processor 14 may operate as the interface between graphics system 112 and computer system 80 by controlling the transfer of data between computer system 80 and graphics system 112. In some embodiments, media processor 14 may also be configured to perform transformations, lighting, and/or other general-purpose processing operations on graphics data.

Transformation refers to the spatial manipulation of objects (or portions of objects) and includes translation, scaling (e.g. stretching or shrinking), rotation, reflection, or combinations thereof. More generally, transformation may include linear mappings (e.g. matrix multiplications), nonlinear mappings, and combinations thereof.

Lighting refers to calculating the illumination of the objects within the displayed image to determine what color values and/or brightness values each individual object will have. Depending upon the shading algorithm being used (e.g., constant, Gourand, or Phong), lighting may be evaluated at a number of different spatial locations.

As illustrated, media processor 14 may be configured to receive graphics data via host interface 11. A graphics queue 148 may be included in media processor 14 to buffer a stream of data received via the accelerated port of host interface 11. The received graphics data may include one or more graphics primitives. As used herein, the term graphics primitive may include polygons, parametric surfaces, splines, NURBS (non-uniform rational B-splines), sub-divisions surfaces, fractals, volume primitives, voxels (i.e., three-dimensional pixels), and particle systems. In one embodiment, media processor 14 may also include a geometry data preprocessor 150 and one or more microprocessor units (MPUs) 152. MPUs 152 may be configured to perform vertex transformation, lighting calculations and other programmable functions, and to send the results to hardware accelerator 18. MPUs 152 may also have read/write access to texels (i.e. the smallest addressable unit of a texture map) and pixels in the hardware accelerator 18. Geometry data preprocessor 150 may be configured to decompress geometry, to convert and format vertex data, to dispatch vertices and instructions to the MPUs 152, and to send vertex and attribute tags or register data to hardware accelerator 18.

As shown, media processor 14 may have other possible interfaces, including an interface to one or more memories. For example, as shown, media processor 14 may include direct Rambus interface 156 to a direct Rambus DRAM (DRDRAM) 16. A memory such as DRDRAM 16 may be used for program and/or data storage for MPUs 152. DRDRAM 16 may also be used to store display lists and/or vertex texture maps.

Media processor 14 may also include interfaces to other functional components of graphics system 112. For example, media processor 14 may have an interface to another specialized processor such as hardware accelerator 18. In the illustrated embodiment, controller 160 includes an accelerated port path that allows media processor 14 to control hardware accelerator 18. Media processor 14 may also include a direct interface such as bus interface unit (BIU) 154. Bus interface unit 154 provides a path to memory 16 and a path to hardware accelerator 18 and video output processor 24 via controller 160.

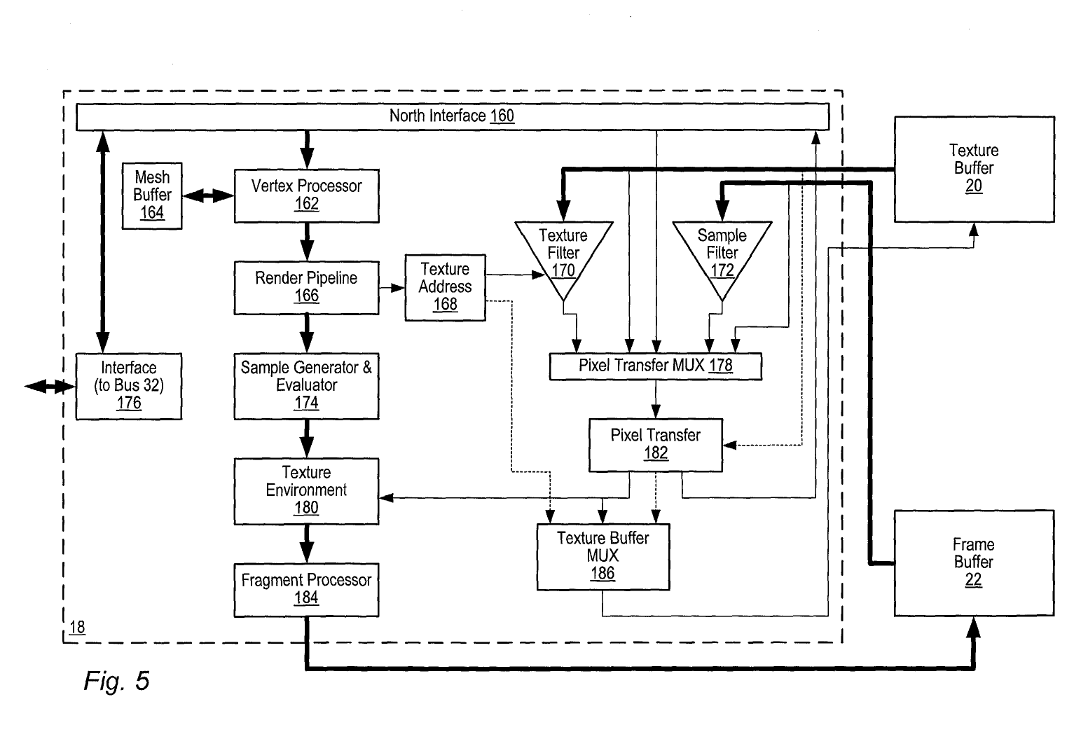

Hardware Accelerator—FIG. 5

One or more hardware accelerators 18 may be configured to receive graphics instructions and data from media processor 14 and to perform a number of functions on the received data according to the received instructions. For example, hardware accelerator 18 may be configured to perform rasterization, 2D and/or 3D texturing, pixel transfers, imaging, fragment processing, clipping, depth cueing, transparency processing, set-up, and/or screen space rendering of various graphics primitives occurring within the graphics data.

Clipping refers to the elimination of graphics primitives or portions of graphics primitives that lie outside of a 3D view volume in world space. The 3D view volume may represent that portion of world space that is visible to a virtual observer (or virtual camera) situated in world space. For example, the view volume may be a solid truncated pyramid generated by a 2D view window, a viewpoint located in world space, a front clipping plane and a back clipping plane. The viewpoint may represent the world space location of the virtual observer. In most cases, primitives or portions of primitives that lie outside the 3D view volume are not currently visible and may be eliminated from further processing. Primitives or portions of primitives that lie inside the 3D view volume are candidates for projection onto the 2D view window.

Set-up refers to mapping primitives to a three-dimensional viewport. This involves translating and transforming the objects from their original “world-coordinate” system to the established viewport's coordinates. This creates the correct perspective for three-dimensional objects displayed on the screen.

Screen-space rendering refers to the calculations performed to generate the data used to form each pixel that will be displayed. For example, hardware accelerator 18 may calculate “samples.” Samples are points that have color information but no real area. Samples allow hardware accelerator 18 to “super-sample,” or calculate more than one sample per pixel. Super-sampling may result in a higher quality image.

Hardware accelerator 18 may also include several interfaces. For example, in the illustrated embodiment, hardware accelerator 18 has four interfaces. Hardware accelerator 18 has an interface 161 (referred to as the “North Interface”) to communicate with media processor 14. Hardware accelerator 18 may receive commands and/or data from media processor 14 through interface 161. Additionally, hardware accelerator 18 may include an interface 176 to bus 32. Bus 32 may connect hardware accelerator 18 to boot PROM 30 and/or video output processor 24. Boot PROM 30 may be configured to store system initialization data and/or control code for frame buffer 22. Hardware accelerator 18 may also include an interface to a texture buffer 20. For example, hardware accelerator 18 may interface to texture buffer 20 using an eight-way interleaved texel bus that allows hardware accelerator 18 to read from and write to texture buffer 20. Hardware accelerator 18 may also interface to a frame buffer 22. For example, hardware accelerator 18 may be configured to read from and/or write to frame buffer 22 using a four-way interleaved pixel bus.

The vertex processor 162 may be configured to use the vertex tags received from the media processor 14 to perform ordered assembly of the vertex data from the MPUs 152. Vertices may be saved in and/or retrieved from a mesh buffer 164.

The render pipeline 166 may be configured to rasterize 2D window system primitives and 3D primitives into fragments. A fragment may contain one or more samples. Each sample may contain a vector of color data and perhaps other data such as alpha and control tags. 2D primitives include objects such as dots, fonts, Bresenham lines and 2D polygons. 3D primitives include objects such as smooth and large dots, smooth and wide DDA (Digital Differential Analyzer) lines and 3D polygons (e.g. 3D triangles).

For example, the render pipeline 166 may be configured to receive vertices defining a triangle, to identify fragments that intersect the triangle.

The render pipeline 166 may be configured to handle full-screen size primitives, to calculate plane and edge slopes, and to interpolate data (such as color) down to tile resolution (or fragment resolution) using interpolants or components such as:

r, g, b (i.e., red, green, and blue vertex color);

r2, g2, b2 (i.e., red, green, and blue specular color from lit textures);

alpha (i.e. transparency);

z (i.e. depth); and

s, t, r, and w (i.e. texture components).

In embodiments using super-sampling, the sample generator 174 may be configured to generate samples from the fragments output by the render pipeline 166 and to determine which samples are inside the rasterization edge. Sample positions may be defined by user-loadable tables to enable stochastic sample-positioning patterns.

Hardware accelerator 18 may be configured to write textured fragments from 3D primitives to frame buffer 22. The render pipeline 166 may send pixel tiles defining r, s, t and w to the texture address unit 168. The texture address unit 168 may use the r, s, t and w texture coordinates to compute texel addresses (e.g. addresses for a set of neighboring texels) and to determine interpolation coefficients for the texture filter 170. The texel addresses are used to access texture data (i.e. texels) from texture buffer 20. The texture buffer 20 may be interleaved to obtain as many neighboring texels as possible in each clock. The texture filter 170 may perform bilinear, trilinear or quadlinear interpolation. The pixel transfer unit 182 may also scale and bias and/or lookup texels. The texture environment 180 may apply texels to samples produced by the sample generator 174. The texture environment 180 may also be used to perform geometric transformations on images (e.g., bilinear scale, rotate, flip) as well as to perform other image filtering operations on texture buffer image data (e.g., bicubic scale and convolutions).

In the illustrated embodiment, the pixel transfer MUX 178 controls the input to the pixel transfer unit 182. The pixel transfer unit 182 may selectively unpack pixel data received via north interface 161, select channels from either the frame buffer 22 or the texture buffer 20, or select data received from the texture filter 170 or sample filter 172.

The pixel transfer unit 182 may be used to perform scale, bias, and/or color matrix operations, color lookup operations, histogram operations, accumulation operations, normalization operations, and/or min/max functions. Depending on the source of (and operations performed on) the processed data, the pixel transfer unit 182 may output the processed data to the texture buffer 20 (via the texture buffer MUX 186), the frame buffer 22 (via the texture environment unit 180 and the fragment processor 184), or to the host (via north interface 161). For example, in one embodiment, when the pixel transfer unit 182 receives pixel data from the host via the pixel transfer MUX 178, the pixel transfer unit 182 may be used to perform a scale and bias or color matrix operation, followed by a color lookup or histogram operation, followed by a min/max function. The pixel transfer unit 182 may then output data to either the texture buffer 20 or the frame buffer 22.

Fragment processor 184 may be used to perform standard fragment processing operations such as the OpenGL® fragment processing operations. For example, the fragment processor 184 may be configured to perform the following operations: fog, area pattern, scissor, alpha/color test, ownership test (WID), stencil test, depth test, alpha blends or logic ops (ROP), plane masking, buffer selection, pick hit/occlusion detection, and/or auxiliary clipping in order to accelerate overlapping windows.

Texture Buffer 20

Texture buffer 20 may include several SDRAMs. Texture buffer 20 may be configured to store texture maps, image processing buffers, and accumulation buffers for hardware accelerator 18. Texture buffer 20 may have many different capacities (e.g., depending on the type of SDRAM included in texture buffer 20). In some embodiments, each pair of SDRAMs may be independently row and column addressable.

Frame Buffer 22

Graphics system 112 may also include a frame buffer 22. In one embodiment, frame buffer 22 may include multiple memory devices such as 3D-RAM memory devices manufactured by Mitsubishi Electric Corporation. Frame buffer 22 may be configured as a display pixel buffer, an offscreen pixel buffer, and/or a super-sample buffer. Furthermore, in one embodiment, certain portions of frame buffer 22 may be used as a display pixel buffer, while other portions may be used as an offscreen pixel buffer and sample buffer.

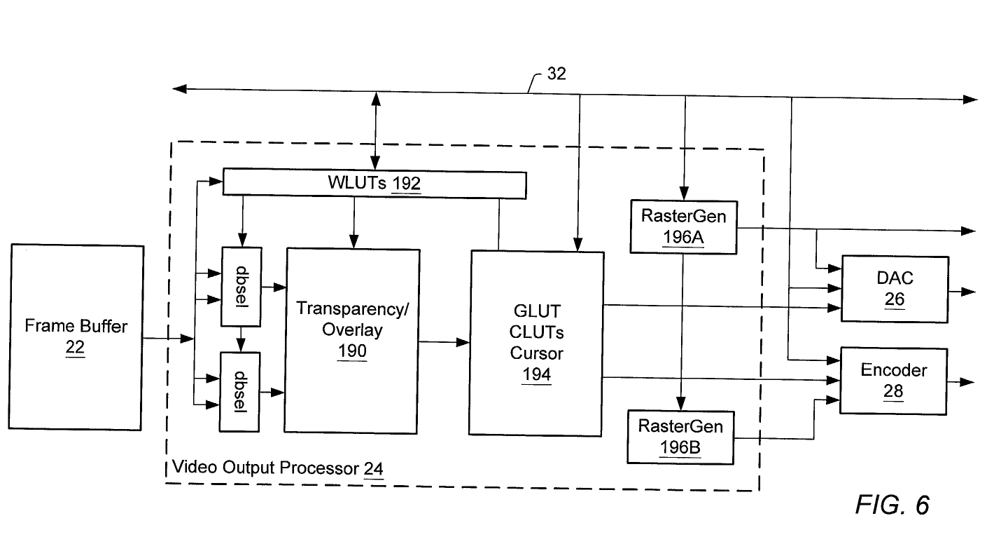

Video Output Processor—FIG. 6

A video output processor 24 may also be included within graphics system 112. Video output processor 24 may buffer and process pixels output from frame buffer 22. For example, video output processor 24 may be configured to read bursts of pixels from frame buffer 22. Video output processor 24 may also be configured to perform double buffer selection (dbsel) if the frame buffer 22 is double-buffered, overlay transparency (using transparency/overlay unit 190), plane group extraction, gamma correction, psuedocolor or color lookup or bypass, and/or cursor generation. For example, in the illustrated embodiment, the output processor 24 includes WID (Window ID) lookup tables (WLUTs) 192 and gamma and color map lookup tables (GLUTs, CLUTs) 194. In one embodiment, frame buffer 22 may include multiple 3DRAM64s 201 that include the transparency overlay 190 and all or some of the WLUTs 192. Video output processor 24 may also be configured to support two video output streams to two displays using the two independent video raster timing generators 196. For example, one raster (e.g., 196A) may drive a 1280×1024 CRT while the other (e.g., 196B) may drive a NTSC or PAL device with encoded television video.

DAC 26 may operate as the final output stage of graphics system 112. The DAC 26 translates the digital pixel data received from GLUT/CLUTs/Cursor unit 194 into analog video signals that are then sent to a display device. In one embodiment, DAC 26 may be bypassed or omitted completely in order to output digital pixel data in lieu of analog video signals. This may be useful when a display device is based on a digital technology (e.g., an LCD-type display or a digital micro-mirror display).

DAC 26 may be a red-green-blue digital-to-analog converter configured to provide an analog video output to a display device such as a cathode ray tube (CRT) monitor. In one embodiment, DAC 26 may be configured to provide a high resolution RGB analog video output at dot rates of 240 MHz. Similarly, encoder 28 may be configured to supply an encoded video signal to a display. For example, encoder 28 may provide encoded NTSC or PAL video to an S-Video or composite video television monitor or recording device.

In other embodiments, the video output processor 24 may output pixel data to other combinations of displays. For example, by outputting pixel data to two DACs 26 (instead of one DAC 26 and one encoder 28), video output processor 24 may drive two CRTs. Alternately, by using two encoders 28, video output processor 24 may supply appropriate video input to two television monitors. Generally, many different combinations of display devices may be supported by supplying the proper output device and/or converter for that display device.

Sample-to-Pixel Processing Flow

In one set of embodiments, hardware accelerator 18 may receive geometric parameters defining primitives such as triangles from media processor 14, and render the primitives in terms of samples. The samples may be stored in a sample storage area (also referred to as the sample buffer) of frame buffer 22. The samples are then read from the sample storage area of frame buffer 22 and filtered by sample filter 22 to generate pixels. The pixels are stored in a pixel storage area of frame buffer 22. The pixel storage area may be double-buffered. Video output processor 24 reads the pixels from the pixel storage area of frame buffer 22 and generates a video stream from the pixels. The video stream may be provided to one or more display devices (e.g. monitors, projectors, head-mounted displays, and so forth) through DAC 26 and/or video encoder 28.

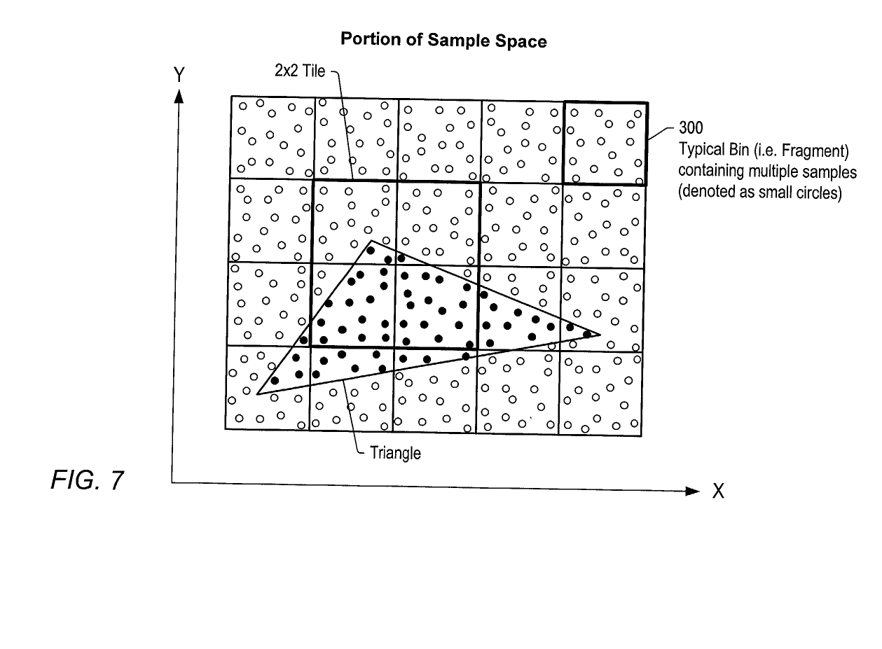

The samples are computed at positions in a two-dimensional sample space (also referred to as rendering space). The sample space may be partitioned into an array of bins (also referred to herein as fragments). The storage of samples in the sample storage area of frame buffer 22 may be organized according to bins as illustrated in FIG. 7. Each bin may contain one or more samples. The number of samples per bin may be a programmable parameter.

Two-Sided Lighting in a Single Pass

Graphics system 112 may be configured to perform two-sided lighting in a single pass. In one set of embodiments, graphics system 112 may be configured to accelerate OpenGL® two-sided lighting. Two-sided lighting may be used when a polygon has different lighting conditions for its front and back faces.

Media processor 14 may receive graphics data (e.g. graphics data sent by a software application executing on host processor 102) through system bus 104. The graphics data may include a stream of vertices that define a collection of graphics primitives such as polygons. The software application may also send lighting parameters defining a number of light sources to media processor 14.

Media processor 14 may perform a two-sided lighting computation on each vertex V_{K} of the vertex stream to determine two color vectors CF_{K} and CB_{K}. Color vector CF_{K} is computed based on the lighting conditions defined for the front face, and color vector CB_{K} is computed based on the lighting conditions defined for the back face. Each color vector may include a number of components such as red, green, blue and alpha. For example, in one embodiment, media processor 14 may implement the OpenGL lighting equation for two-sided lighting to compute the color vectors CF_{K} and CB_{K} for each vertex V_{K}. The lighting computation may incorporate information about the light sources and the current position of a virtual viewer in a virtual world space.

Media processor 18 may also perform a number of spatial transformations (e.g. linear and/or non-linear transformations) on the vertices V_{K} before and/or after the lighting computation.

Media processor 14 may send each vertex V_{K} along with its front and back color vectors CF_{K} and CB_{K} to hardware accelerator 18. The vertex V_{K} as sent from media processor 14 may be represented by a point (Xₖ,Yₖ,Z_{K}) in a three-dimensional space, e.g., a screen space or viewport coordinate space. Alternatively, the vertex V_{K} as sent from media processor 14 may be represented by a point (Xₖ,Yₖ,Z_{K},W_{K}) in homogenous coordinates.

Hardware accelerator may include a vertex processor 162 as shown in FIG. 5. Vertex processor 162 may assemble triangles (or, more generally, polygons) from the stream of vertices V_{K}. In one set of embodiments, the graphics data stream (as sent down to graphics system 112 from the host) may include a replacement code R_{K} for each vertex V_{K}. Vertex processor 162 may use the replacement codes R_{K} to assemble the vertices V_{K} into triangles T_{K}.

For more information on the assembly of primitives using replacement codes, please refer to:

(a) U.S. patent application Ser. No. 10/060,969, entitled “Vertex Assembly Buffer and Primitive Launch Buffer”, filed Jan. 30, 2002, invented by Lavelle, Pan & Ramirez, which is hereby incorporated by reference in its entirety; and

(b) U.S. Pat. No. 5,793,371, issued on Aug. 11, 1998, entitled “Method and Apparatus for Geometric Compression of Three-Dimensional Graphics Data” by Michael F. Deering, which is incorporated herein by reference in its entirety;

(c) Appendix B of “The Java3D™ API Specification, Version 1.2, April 2000”, copyright© 2000, SunMicrosystems, Inc.

Vertex processor 162 may send assembled triangles T_{K} to render pipe 166. Each triangle T_{K} includes three “two-sided” vertices V_{A}, V_{B} and V_{C}, i.e. each vertex may include a front color vector CF and a back color vector CB as well as x, y, z and w coordinates.

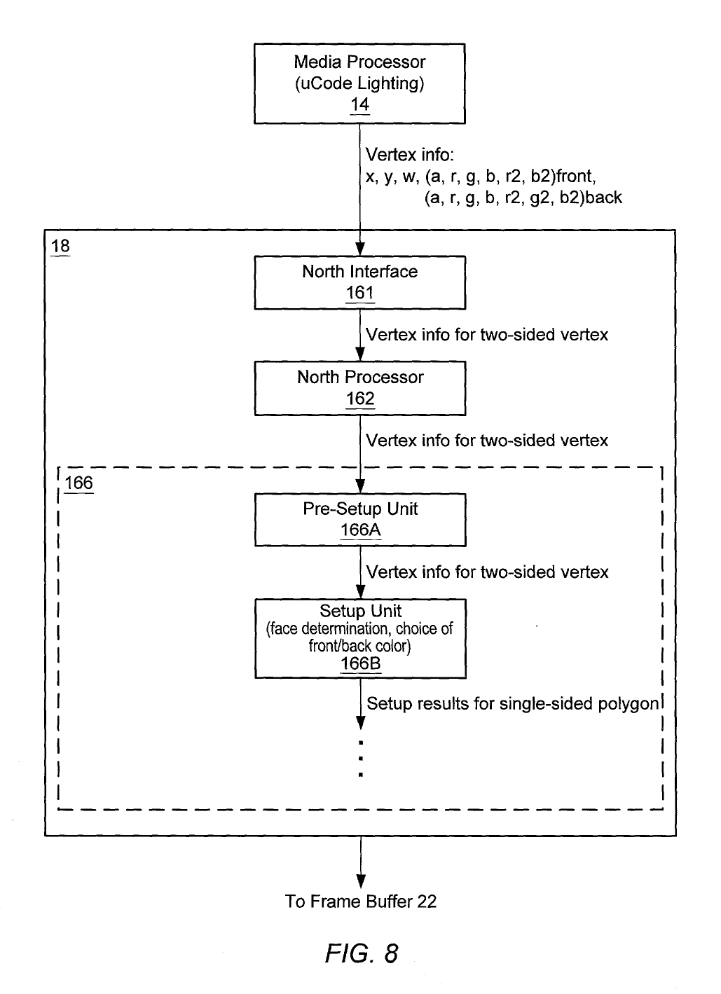

Render pipe 166 may include a presetup unit 166A and a setup unit 166B as illustrated in FIG. 8. Render pipe 166 may also include an edge walking unit and a span walking unit (not shown).

Setup unit 166B may perform an orientation computation to determine if triangle T_{K} is clockwise or counterclockwise as seen by the virtual observer. In other words, the orientation computation determines if the front side or the back side of the triangle is facing the virtual observer. The result of the orientation computation is an orientation bit that reports either FRONT or BACK. Any of various methods may be used to perform the triangle orientation computation.

For more information on one method for computing the orientation of the triangle T_{K} using the position coordinates of the vertices V_{A}, V_{B} and V_{C}, please refer to U.S. patent application Ser. No. 09/752,113, filed on Dec. 29, 2000, entitled “Graphics System Configured to Determine Triangle Orientation by Octant Identification and Slope Comparison”, invented by Michael F. Deering.

The orientation bit B_{K} determined for triangle T_{K} is used to select either the front color vectors or the back color vectors for the vertices V_{A}, V_{B} and V_{C}. In other words, if the front side of the triangle T_{K} is facing the viewer, the front color vectors may be retained and the back color vectors may be rejected (i.e. dropped). Conversely, if the back side of the triangle T_{K} is facing the viewer, the back color vectors may be retained and the front color vectors may be rejected (i.e. dropped).

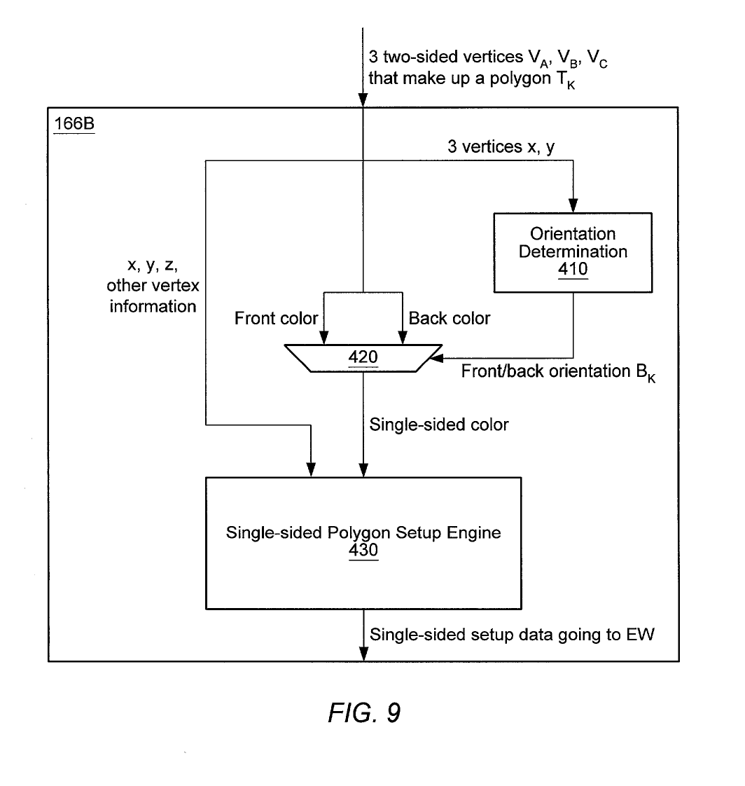

FIG. 9 illustrates one embodiment of setup unit 166B. Setup unit 166B receives three two-sided vertices V_{A}, V_{B}, V_{C} that define a triangle T_{K}. Position coordinates x, y, z, and other data values for each vertex may be forwarded to single-sided polygon setup engine 430.

A selection unit 420 (e.g. a multiplexor unit) receives the front color information and the back color information for each vertex, and selects either the front color information for all three vertices or the back color information for all three vertices based on the value of front/back orientation bit B_{K} of the triangle T_{K}. The selection unit 420 couples to setup engine 430, and passes to setup engine 430 the selected single-sided color information. Thus, setup engine 430 and other succeeding units perform rendering computations on the triangle as a single-sided entity.

The front/back orientation bit B_{K} may be computed by orientation determination unit 410. Orientation determination unit 410 may operate on the x,y position coordinates of the vertices V_{A}, V_{B}, V_{C} that define the triangle T_{K}.

Setup engine 430 may perform additional setup computations to prepare for further rendering computations down stream in the render pipe 166.

In one alternative embodiment, media processor 14 performs lighting for one side (say the front side) of vertices in the received vertex stream, and thus, sends a single color vector corresponding to the single side of each vertex to hardware accelerator. Thus, in this embodiment, setup unit 166B does not include selection unit 420. The orientation bit B_{K} for a triangle T_{K} generated by orientation determination unit 420 may be used to determine whether triangle T_{K} is to be culled, or, sent downstream to be rendered into samples. To support two-sided lighting in this embodiment, graphics system may use two passes of lighting (in the media processor 14) and rendering (in the hardware accelerator). The first pass may be used to draw front-facing polygons, while culling out the back-facing polygons. The second pass may be used to draw the back-facing polygons, while culling out the front-facing polygons. Hardware accelerator 19 may include programmable register SIDE_SELECT which determines which side of triangles are retained versus culled.

In one embodiment, graphics system 112 may include one or more programmable registers that allow the two-sided lighting functionality to be turned on or off. As described, if the two-sided lighting functionality is turned off, the host application may achieve two-sided lighting by sending down a given set of triangles in two passes.

The methods described herein for performing two-sided lighting on triangles in a graphics accelerator naturally generalize to polygons with any number of sides.

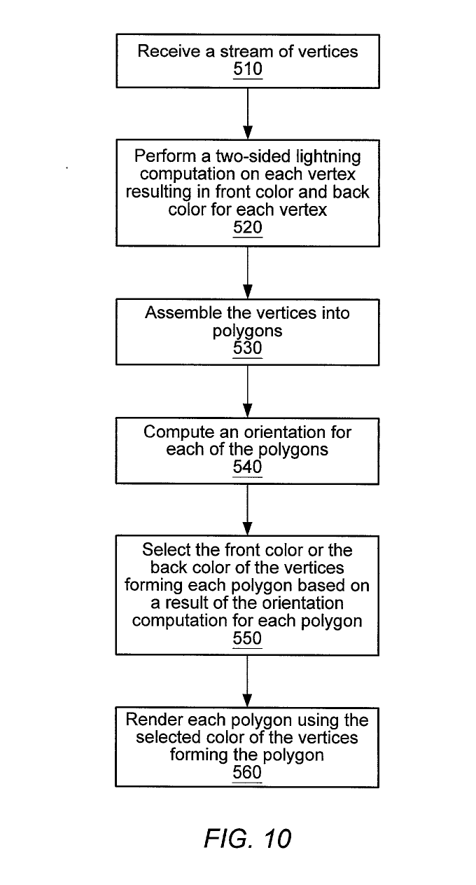

In one set of embodiments, a method for performing two-sided lighting may involve the following steps as shown in FIG. 10. In step 510, a first processor may receive a stream of vertices. In step 520, the first processor may perform a two-sided lighting computation on each vertex resulting in front color and back color for each vertex. In step 530, a second processor may receive the vertices from the first processor and may assemble the vertices into polygons. In step 540, the second processor may compute an orientation for each of the polygons. In step 550, the second processor may select the front color or the back color of the vertices forming each polygon based on a result of the orientation computation for each polygon. In step 560, the second processor may render each polygon using the selected color of the vertices forming the polygon. The first processor may be optimized for operating on vertices and performing lighting computations. The second processor may include dedicated circuitry for performing the orientation computation, for rendering polygons into samples and for filtering samples into pixels.

In some embodiments, one or more general-purpose processors may be used to realize the first processor and/or the second processor.

Although the embodiments above have been described in considerable detail, other versions are possible. Numerous variations and modifications will become apparent to those skilled in the art once the above disclosure is fully appreciated. It is intended that the following claims be interpreted to embrace all such variations and modifications. Note the section headings used herein are for organizational purposes only and are not meant to limit the description provided herein or the claims attached hereto.

What is claimed is:

1. A graphics system for providing two-sided lighting, the system comprising:
a media processor configured to receive a stream of vertices, and to perform a two-sided lighting computation on each vertex resulting in front color and back color for each vertex;
a hardware accelerator configured (a) to receive the vertices of the first stream along with the front and back color for each vertex, (b) to assemble the vertices into polygons, (c) to compute an orientation for each of said polygons, (d) to select the front color or the back color of the vertices forming each polygon based on a result of the orientation computation for each polygon, (e) to render each polygon using the selected color for the vertices forming the polygon.

2. The graphics system of claim 1 further comprising a frame buffer, wherein the hardware accelerator is configured to render each polygon, using the selected color of the vertices forming the polygon, to generate samples, and to store the samples in the frame buffer.

3. The graphics system of claim 1 further comprising a frame buffer, wherein the hardware accelerator is configure store samples resulting from the rendering of the polygons into the frame buffer.

4. The graphics system of claim 3 where in the hardware accelerator is further configured to read the samples from the frame buffer, and to filter the samples to determine pixel values, wherein the pixel values define at least a portion of a displayable image.

5. A method for performing two-sided lighting, the method comprising:
receiving a stream of vertices; performing a two-sided lighting computation on each vertex resulting in front color and back color for each vertex;
assembling the vertices into polygons;
computing an orientation for each of said polygons;
selecting the front color or the back color of the vertices forming each polygon based on a result of the orientation computation for each polygon;
rendering each polygon using the selected color of the vertices forming the polygon.
